(19) United States
(12) Patent Application Publication
(10) Pub. No.: US 2005/0069661 A1
(43) Pub. Date: Mar. 31, 2005

(54) Flexible article having sense of touch and method of manufacturing same

(76) Inventor: Chih-Yang Yi, Taipei (TW)

Correspondence Address: CHIH-YANG YI;4 FL. 27 Lane 160, Hsin Sheng S. Road, Sec. 1, Taipei, 100, CN

(21) Appl. No.: 10/815,781

(22) Filed: Apr. 2, 2004

(30) Foreign Application Priority Data
Sep. 30, 2003 (TW) 092126997

(51) Int. Cl. B65D 1/00; B29C 45/00

(52) U.S. Cl. 428/35.2; 264/328.1; 156/69; 156/145

(57) ABSTRACT

Flexible article having sense of touch and method of manufacturing same is disclosed. The article comprises a hollow member formed by injection molding of TPR, and a jellylike substance filled in the hollow member, the jellylike substance being formed from PVA solution. Preferably, the PVA solution is comprised of 3 wt % to 30 wt % PVA, 20 wt % to 85 wt % water, 0.5 wt % to 10 wt % plasticizer, and 0 wt % to 20 wt % softness enhancing additive.

### BACKGROUND OF THE INVENTION

1. Field of the Invention

The present invention relates to flexible articles made of plastic material and more particularly to such a flexible article having sense of touch and method of manufacturing the same.

2. Description of Related Art

A conventional flexible article such as one disclosed in Taiwanese Patent Published No. 454,550 entitled “Improved Flexible Article” is shown in FIGS. 9 and 10. It comprises a flexible, hollow ball formed of transparent or translucent plastic material. Liquid (e.g., water) mixed with dye, and many very small solid bodies are filled therein. The flexible article is used as exercise equipment. As such, a user can hold and repeatedly press the flexible article by hand. In a commercial product manufactured according to the above patent, only water is filled therein. As such, the sense of touching or pressing the flexible article is merely about that of touching or pressing a balloon filled with water. Thus, the claimed exercise purpose of the hand is compromised.

There are many similar products commercially available in which characteristics and drawbacks of three of them will be described in detail below.

The first one is PU (polyurethane) foam ball which is manufactured by filling plastic foam in a mold and heating the mold to form a porous ball. Its drawbacks are too soft, the number of available designs being small, high manufacturing cost, and prolonged manufacturing time.

The second one is silicone-rubber coated with PU film which is manufactured by filling PU in a mold, heating to form a hole in the mold, filling silicone-rubber and hardener into the hole, and heating the mold for closing the hole and finishing the product. It is advantageous of being suitably soft and having the sense of touch. Hence, such material is widely used in manufacturing bra. However, it still has drawbacks of being high in manufacturing cost, requiring many molds and heating equipment, prolonged manufacturing time, low production, and the number of available designs being small.

The third one is a flexible article manufactured by dipping foam rubber through a hole to form a hollow article having a film thickness about 1 mm or less, filling maltose into the article, tying the hole, and decorating the blocked hole so as to finish the product. It is advantageous of being suitably soft. However, it still has the following drawbacks: (i) Maltose may be hardened in a cold environment (e.g., winter). Hence, the sense of touching a soft article cannot be perceived. (ii) The designs are limited because the thickness of foam rubber film is very small, foam rubber is difficult of adhering to another object thus requiring to tie the hole, and a not so aesthetic decoration is placed on the blocked hole. Thus, the need for improvement still exists.

### SUMMARY OF THE INVENTION

It is an object of the present invention to provide a flexible article having sense of touch. The present invention can be used as hand exercise equipment or the like.

It is another object of the present invention to provide a method of manufacturing a flexible article contained jellylike substance so that a degree of comfortable can be perceived by the organ (e.g., hand) touched it. The manufacturing process is advantageous for being simple. Also, properties of the form article can be adjusted by precisely controlling percentages of constituent components. Moreover, the manufacturing time is short and a variety of shapes of the articles can be formed depending on applications.

In one aspect of the present invention a flexible article having sense of touch is provided. The flexible article comprises a hollow member formed by injection molding of TPR; and a jellylike substance filled in the hollow member, the jellylike substance being formed from PVA solution including 3 wt % to 30 wt % PVA, 20 wt % to 85 wt % water, 0.5 wt % to 10 wt % plasticizer, and 0 wt % to 20 wt % softness enhancing additive.

In another aspect of the present invention, a method of manufacturing a flexible article having sense of touch is provided. The method comprises the steps of (i) forming a hollow ball by injection molding of TPR with a hole formed thereon; (ii) forming a cap by injection molding of TPR, the cap including a thick, cylindrical body and a thin peripheral member having a diameter equal to or larger than that of the hole; (iii) adhering the cap to the ball by applying adhesive to both the cap and the hole for blocking the hole so as to form an airtight ball; (iv) injecting PVA solution into the ball by piercing through the body by a syringe; (v) injecting plasticizer solution into the ball; and (vi) rubbing the ball for about predetermined seconds and plasticizing the solution contained in the ball in a room temperature for forming a flexible article contained jellylike substance.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of flexible article according to the invention;

FIG. 2 is a perspective view of a second preferred embodiment of flexible article according to the invention;

FIGS. 3, 4, 5, and 6 are cross-sectional views of the hollow, ball article shown in FIG. 1 for illustrating manufacturing steps thereof;

FIG. 7 is a perspective view of the article shown in FIG. 1, where the article is held and pressed by the hand;

FIG. 8 is a flow chart showing a sequence of method steps performed by the invention;

FIG. 9 is a perspective view of a conventional flexible article; and

FIG. 10 is another perspective view of the article shown in FIG. 9, where the article is held and pressed by the hand.

### DETAILED DESCRIPTION OF THE PREFERRED EMBODIMENTS

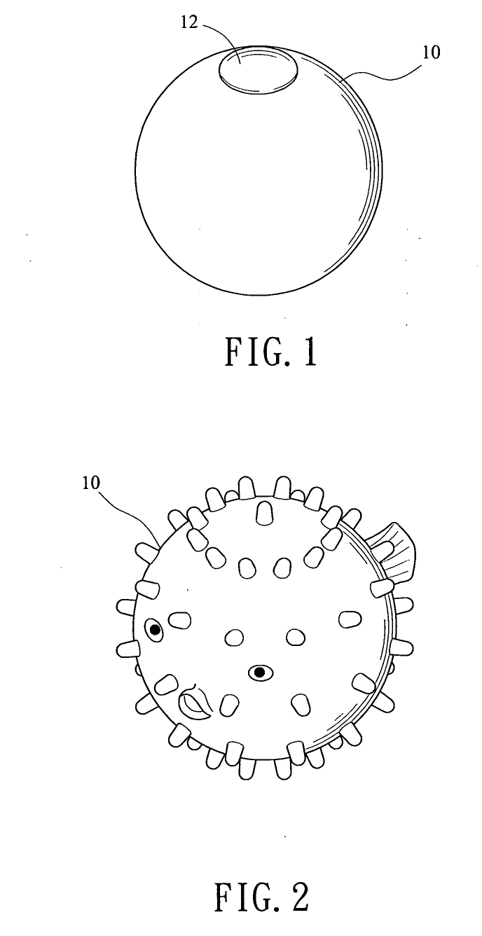

Referring to FIG. 2, there is shown a flexible article 10 constructed in accordance with a second preferred embodiment of the invention. The article 10 has the shape of a fish. Referring to FIG. 1, there is shown another flexible article 10 constructed in accordance with a second preferred embodiment of the invention. The invention will be described in detail with respect to the article 10 shown in FIG. 1 for the sake of simplicity and illustration.

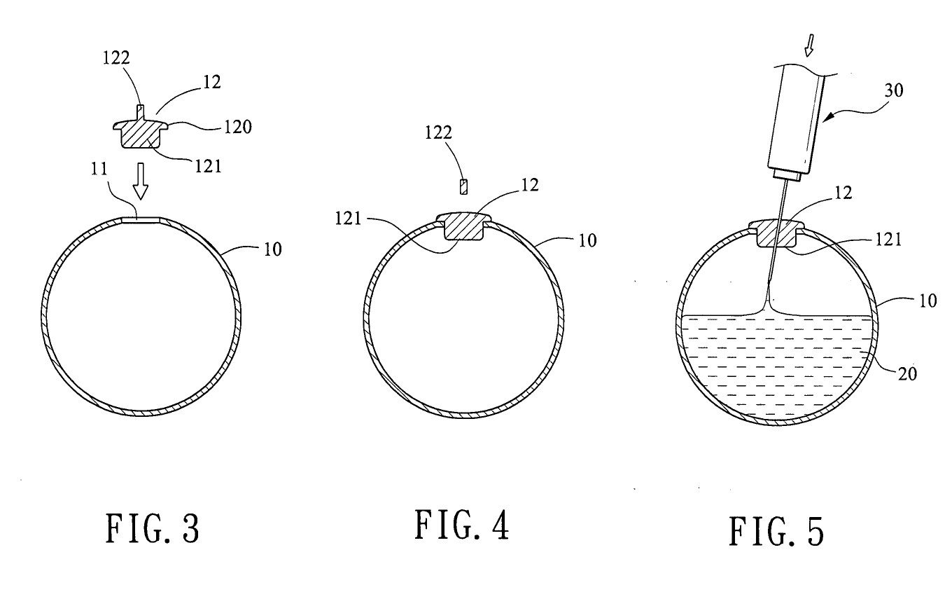

Referring to FIGS. 3 to 7, the flexible article 10 is hollow and is manufactured by injection molding of TPR (thermoplastic rubber). The hollow article 10 is filled with a jellylike substance formed from PVA (or PVOH in some other embodiment) (polyvinyl alcohol) solution which is comprised of 3% to 30% PVA, 20% to 85% water, 0.5% to 10% plasticizer, and 0.0% to 20% softness enhancing additive based on weight (i.e., 3 wt % to 30 wt % PVA, 20 wt % to 85 wt % water, 0.5 wt % to 10 wt % plasticizer, and 0.0 wt % to 20 wt % as labeled hereinafter.) These four constituent components are well mixed in the article 10. Next, the manufacturing process is conducted in a room temperature environment. The formed product is an excellent article having sense of touch.

In one embodiment, for manufacturing flexible articles having a relatively soft property and a jellylike substance, preferably, the PVA solution is comprised of 4 wt % PVA, 80 wt % water, 1 wt % plasticizer, and 15 wt % softness enhancing additive. In another embodiment, for manufacturing flexible articles having a relatively flexible property and a solid substance, preferably, the PVA solution is comprised of 30 wt % PVA, 60 wt % water, 10 wt % plasticizer, and 0 wt % softness enhancing additive.

Note that it is possible of controlling softness, flexibility, ductility, and density of molecules of the formed flexible article by changing constituent components of the PVA solution. For example, an increase of PVA will decrease softness and increase flexibility of the flexible article. Also, an increase of water will decrease softness of the flexible article. Moreover, an increase of plasticizer will decrease density of molecules, decrease softness and ductility, and increase flexibility of the flexible article. In addition, an increase of softness enhancing additive will increase softness and ductility but decrease flexibility of the flexible article. Property changes versus different percentages of constituent components of PVA solution is tabulated below in which → means weight percentage increases, ↑ means property increases, and ↓ means property decreases.

| | | Property changes versus different | | | |
|---|---|---|---|---|---|
| | | percentages of constituent components | | | |
| Constituent | Weight | | | | density |
| components | percentage | softness | flexibility | ductility | of molecules |
| PVA | 3%→30% | ↓ | ↑ | — | — |
| Water | 20%→85% | ↑ | — | — | — |
| plasticizer | 0.5%→10% | ↓ | ↑ | ↓ | ↑ |
| softness | 0%→20% | ↑ | ↓ | ↑ | — |
| enhancing | | | | | |
| additive | | | | | |

TPR of the invention is comprised of styrene-ethylene-butylene-styrene copolymer (SEBS) available from a US company SHELL. Alternatively, TPR of the invention is comprised of hydrogenated styrene isoprene/butadiene block copolymer (SEPS) available from a Japanese company KURARAY.

The manufacturing process of flexible article of the invention can be illustrated by referring to FIGS. 3 to 7 specifically. One of various shapes (e.g., animal, human being, or the like) can be formed by injection molding of highly flexible TPR in which a hollow ball 10 is formed in the embodiment. The hollow ball 10 comprises a hole 11 on its surface and a flexible cap 12 shaped to fit in the hole 11 (FIGS. 3 and 4). The cap 12 comprises a thick, cylindrical body 121, a thin peripheral member 120, and a top post 122. The peripheral member 120 has a diameter equal to or larger than that of the hole 11 so that the peripheral member 120 is adapted to secure onto the hole 11 by applying adhesive thereto. Thus, an airtight ball 10 is formed. Next, remove the top 122 and polish the hole 11 so as to form a substantially smooth surface on the hole 11 (FIG. 4). If desired, paint or spray color on the ball for forming a colorful one. At this stage, the ball is similar to a conventional balloon.

Next, fill a PVA solution 20 into the ball 10. In detail, PVA is solvable in water to form a solution comprised of 3 wt % to 30 wt % PVA. The prepared PVA solution 20 is then injected into the hollow ball 10 by piercing through the body 121 of the cap 12 by a syringe 30 (FIG. 5). The filled PVA solution 20 will not leak since the body 121 has a highly dense, flexible structure. Note that air inside the ball 10 is also evacuated in the injection process.

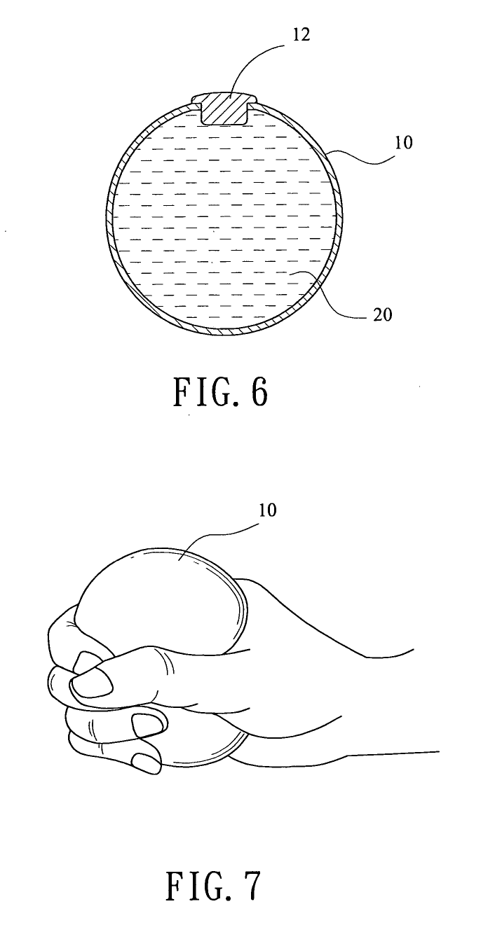

Also, plasticizer such as Na2CO3, Na2SO4, (NH4)2SO4, boric acid (H3BO3), borax (Na2B4O7.10H2O), or the like is mixed with water to form a solution containing 0.5 wt % to 10 wt % plasticizer. The plasticizer solution is injected into the ball 10 in a similar step as above. Next, rub the ball 10 for about 5 to 10 seconds so that plasticization of the plasticizer solution can be performed in a room temperature environment. A flexible article contained jellylike substance is thus formed (FIG. 6). The flexibility of the product can be adjusted by preparing different percentages of water, PVA, and plasticizer.

Moreover, for obtaining a flexible article having a desired softness and ductility, softness enhancing additive such as glycerin (C3H5(OH)3), ethylene glycol (C2H4(OH)2), polyethylene glycols (H(OCH 2CH 2)70H), propylene glycol (C3H6(OH)2), triethanol amineacetate or the like can be mixed with water to form a solution containing 0.0 wt % to 20 wt % softness enhancing additive. The formed softness enhancing additive solution is then injected in a similar step as above. Note that the step of injecting softness enhancing additive into the ball can be performed in the above two steps.

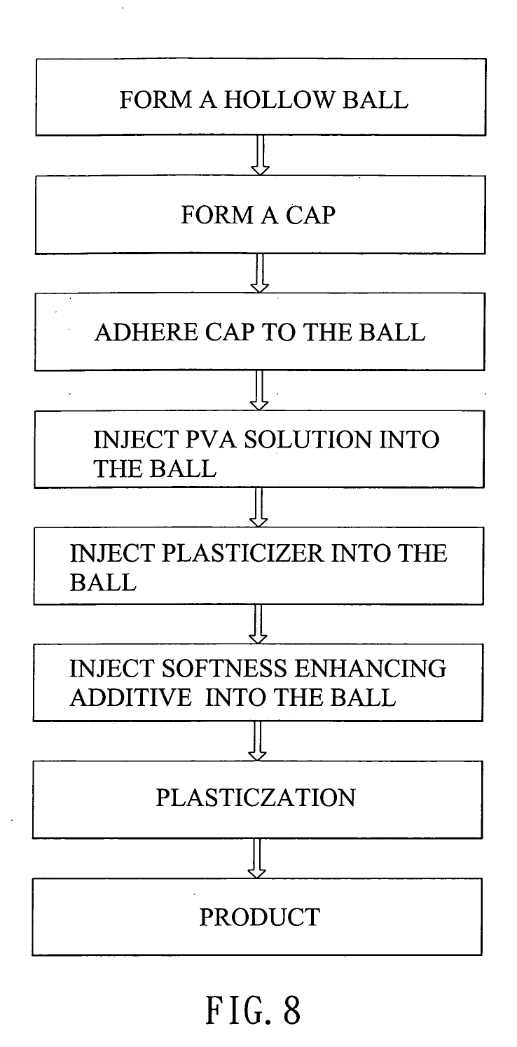

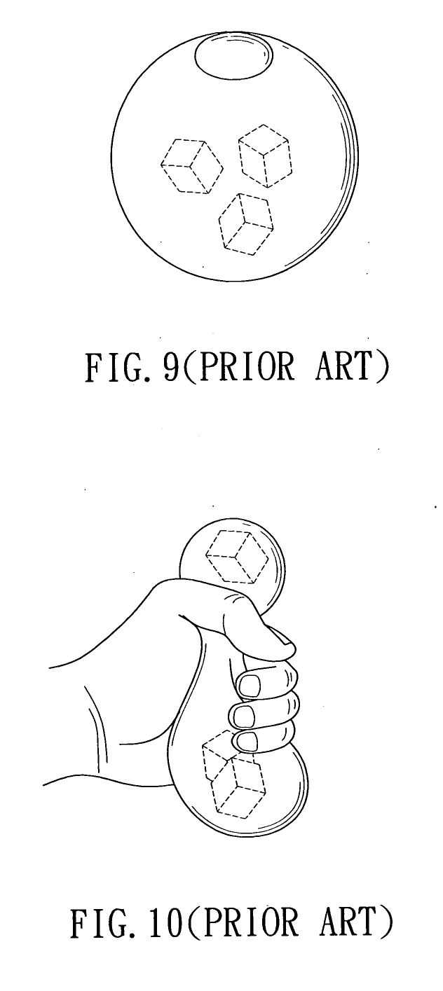

Referring to FIG. 8, there is shown a flow chart showing a sequence of method steps performed by the invention. In step 1 of forming a hollow ball 10, mold a hollow ball by injection molding of TPR with a hole 11 formed thereon (FIG. 3). In step 2 of forming a cap 12, mold a cap 12 by injection molding of TPR. The cap 12 comprises a thick, cylindrical body 121 and a thin peripheral member 120 having a diameter equal to or larger than that of the hole 11 of the ball 10 (FIG. 3). In step 3 of adhering the cap 12 to the hollow ball 10, apply adhesive to both the cap 12 and the hole 11 for blocking the hole 11. Thus, an airtight ball 10 is formed (FIG. 4). In step 4 of injecting PVA solution into the ball, inject the prepared PVA solution containing 3 wt % to 30 wt % PVA into the hollow ball 10 by piercing through the body 121 of the cap 12 by a syringe 30 (FIG. 5). In step 5 of injecting plasticizer into the ball, inject the prepared plasticizer solution containing 0.5 wt % to 10 wt % plasticizer into the hollow ball 10 (FIG. 5). In step 6 of injecting softness enhancing additive into the ball, inject the prepared plasticizer solution containing 0.0 wt % to 20 wt % softness enhancing additive into the hollow ball 10 for adjusting softness and ductility of the product to be formed. This step can be performed in the steps 4 and 5. In step 7 of plasticization, rub the ball for about 5 to 10 seconds. Next, plasticization of the solution contained in the ball will be performed automatically. Finally, a flexible article contained jellylike substance is formed. Note that the step 6 can be omitted if softness and ductility adjustment of the product is not needed.

While the invention herein disclosed has been described by means of specific embodiments, numerous modifications and variations could be made thereto by those skilled in the art without departing from the scope and spirit of the invention set forth in the claims.

1. A flexible article having sense of touch, comprising:
a hollow member formed by injection molding of TPR; and
a jellylike substance filled in the hollow member, the jellylike substance being formed from PVA solution including PVA, water, and plasticizer.

2. The flexible article of claim 1, wherein the PVA solution further comprises softness enhancing additive.

3. The flexible article of claim 1, wherein the PVA solution is comprised of 3 wt % to 30 wt % PVA, 20 wt % to 85 wt % water, and 0.5 wt % to 10 wt % plasticizer.

4. The flexible article of claim 1, wherein the PVA solution is comprised of 30 wt % PVA, 60 wt % water, and 10 wt % plasticizer.

5. The flexible article of claim 1, wherein the plasticizer is selected from a group comprising Na2CO3, Na2SO4, (NH4)2SO4, boric acid (H3BO3), and borax (Na2B4O7.10H2O).

6. The flexible article of claim 2, wherein the softness enhancing additive has a weight percentage 0% to 20% of the PVA solution.

7. The flexible article of claim 2, wherein the PVA solution is comprised of 4 wt % PVA, 80 wt % water, 1 wt % plasticizer, and 15 wt % softness enhancing additive.

8. The flexible article of claim 2, wherein the softness enhancing additive is selected from a group comprising glycerin (C3H5(OH)3), ethylene glycol (C2H4(OH)2), polyethylene glycols (H(OCH 2CH 2)7OH), propylene glycol (C3H6(OH)2), and triethanol amineacetate.

9. A method of manufacturing a flexible article having sense of touch, comprising the steps of:
(i) forming a hollow member by injection molding of TPR with a hole formed thereon;
(ii) forming a cap by injection molding of TPR, the cap including a thick, cylindrical body and a thin peripheral member having a diameter equal to or larger than that of the hole;
(iii) adhering the cap to the ball by applying adhesive to both the cap and the hole for blocking the hole so as to form an airtight member;
(iv) injecting PVA solution into the member by piercing through the body by a syringe;
(v) injecting plasticizer solution into the member; and
(vi) rubbing the member for about predetermined seconds and plasticizing the solution contained in the member in a room temperature for forming a flexible article contained jellylike substance.

10. The method of claim 9, further comprising the step of (v-a) injecting softness enhancing additive into the member to mix with the solution containing PVA, water, and plasticizer in a room temperature for increasing softness and ductility of the formed article before carrying out the step (vi).

11. The flexible article of claim 9, wherein the plasticizer is selected from a group comprising Na2CO3, Na2SO4, (NH4)2SO4, boric acid (H3BO3), and borax (Na2B4O7.10H2O).

12. The method of claim 9, further comprising the step of (iv-a) injecting softness enhancing additive into the member to mix with the solution containing PVA and water before carrying out the step (v).

13. The flexible article of claim 10, wherein the softness enhancing additive is selected from a group comprising glycerin (C3H5(OH)3), ethylene glycol (C2H4(OH)2), polyethylene glycols (H(OCH 2CH 2)7OH), propylene glycol (C3H6(OH)2), and triethanol amineacetate.

14. The flexible article of claim 9, wherein the PVA solution is comprised of 3 wt % to 30 wt % PVA, 20 wt % to 85 wt % water, and 0.5 wt % to 10 wt % plasticizer.

15. The flexible article of claim 10, wherein the softness enhancing additive has a weight percentage 0% to 20% of the PVA solution.
